(19) United States
(12) Patent Application Publication
(10) Pub. No.: US 2025/0091513 A1
(43) Pub. Date: Mar. 20, 2025

(54) ELECTRONIC DEVICE FOR PERFORMING INTEGRATED MULTI-FUNCTIONS USING SINGLE REAR VIEW IMAGE OF VEHICLE, AND OPERATING METHOD OF THE SAME

(71) Applicant: THINKWARE CORPORATION, SEONGNAM-SI (KR)

(72) Inventors: Ho Kwan LEE, SEONGNAM-SI (KR); Hyun Chul CHO, SEONGNAM-SI (KR)

(21) Appl. No.: 18/882,780

(22) Filed: Sep. 12, 2024

(30) Foreign Application Priority Data
Sep. 14, 2023 (KR) 10-2023-0122307
Aug. 26, 2024 (KR) 10-2024-0114084

(51) Int. Cl. B60R 1/12; B60R 1/26

(52) U.S. Cl. CPC B60R 1/12; B60R 1/26; B60R 2001/1215; B60R 2001/1253; B60R 2001/1284

(57) ABSTRACT

Provided are an electronic device for performing an integrated multi-function using a single rear view image of a vehicle and an operating method thereof. Herein, the electronic device is configured to receive a rear view image from a camera device and to process the rear view image to a plurality of target images for a plurality of functions. For a function of a digital image recording system function, the electronic device may store the rear view image as a first target image. For an around view monitoring function, the electronic device may display a portion of the rear view image as a second target image that is a portion of an around view image around the vehicle. For a digital rear view monitoring function, the electronic device may display a portion of the rear view image on a digital rear mirror as a third target image.

### CROSS-REFERENCE TO RELATED APPLICATION(S)

This application claims the priority benefit of Korean Patent Application Nos. 10-2023-0122307, filed on Sep. 14, 2023 and 10-2024-0114084, filed on Aug. 26, 2024, in the Korean Intellectual Property Office, the disclosure of which is incorporated herein by reference.

### BACKGROUND

### 1. Field of the Invention

Example embodiments relate to an electronic device for performing an integrated multi-function using a single rear view image and an operating method thereof.

### 2. Description of the Related Art

Typically, a plurality of rear cameras for different functions are installed in a vehicle. Therefore, an electronic device in the vehicle is connected to each of the rear cameras through cables embedded in the vehicle, and receives and processes each of a plurality of rear view images from the rear cameras. This results in an increase in the number of hours of work used to install the rear cameras in the vehicle, an increase in installation cost due to unit cost of the rear cameras and cables, and an increase in the weight of the vehicle in which the rear cameras are installed.

### SUMMARY

Example embodiments provide an electronic device for performing an integrated multi-function using a single rear view image received from a rear camera device of a vehicle and an operating method thereof.

According to an aspect, there is provided an electronic device connected to a camera device that captures a rear view image of a vehicle, the electronic device including an interface module configured to communicatively connect to the camera device; and a processor configured to connect to the interface module, and to process the rear view image received through the interface module to a plurality of target images for a plurality of functions.

According to an aspect, there is provided an operating method of an electronic device connected to a camera device that captures a rear view image of a vehicle, the method including receiving the rear view image from the camera device; and processing the rear view image to a plurality of target images for a plurality of functions.

According to an aspect, there is provided a image processing system including a camera device configured to capture a rear view image of a vehicle; and an electronic device configured to process the rear view image to a plurality of target images for a plurality of functions.

According to an aspect, there is provided an operating method of a image processing system including a camera device and an electronic device, the method including capturing, by the camera device, a rear view image of a vehicle; and processing, by the electronic device, the rear view image to a plurality of target images for a plurality of functions.

According to some example embodiments, an electronic device may perform an integrated multi-function using a single rear view image of a vehicle. That is, the electronic device may process the rear view image to a plurality of target images for a plurality of functions. The functions may include at least one of a digital video recording system (DVRS) function, an around view monitoring (AVM) function, and digital rear view monitoring (DRM) function. Accordingly, since only one rear camera device may be installed in the vehicle, the number of camera devices installed in the vehicle may be reduced. This may lead to a decrease in the number of hours of work used to install the rear cameras in the vehicle, a decrease in installation cost due to unit cost of the rear cameras and cables, and a decrease in the weight of the vehicle in which the rear cameras are installed.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating a configuration of a image processing system according to various example embodiments;

FIG. 2 is an example diagram for explaining a first function of an electronic device of FIG. 1;

FIG. 3 is an example diagram for explaining a second function of the electronic device of FIG. 1;

FIG. 4 is an example diagram for explaining a third function of the electronic device of FIG. 1;

FIGS. 5A, 5B, and 5C are flowcharts illustrating an operating method of a image processing system according to various example embodiments;

FIG. 6 is a block diagram illustrating an internal configuration of an electronic device according to various example embodiments;

FIG. 7 is a block diagram illustrating a detailed configuration of a processor of FIG. 6;

FIG. 8 is a flowchart illustrating an operating method of an electronic device according to various example embodiments;

FIG. 9 is a block diagram illustrating a vehicle to which a image processing system is mounted according to various example embodiments; and

FIG. 10 is a block diagram illustrating a control device of the vehicle of FIG. 9.

### DETAILED DESCRIPTION

Hereinafter, various example embodiments are described with reference to the accompanying drawings.

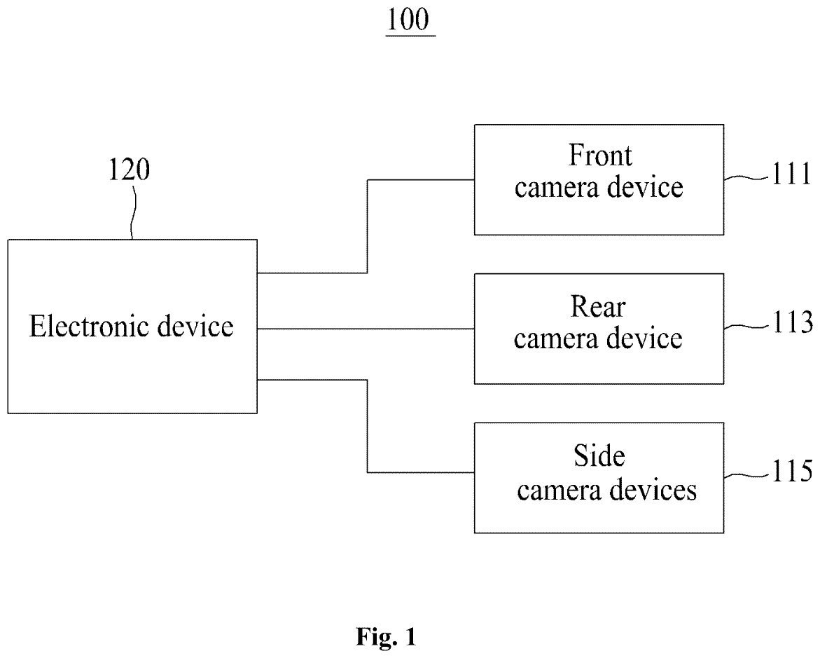

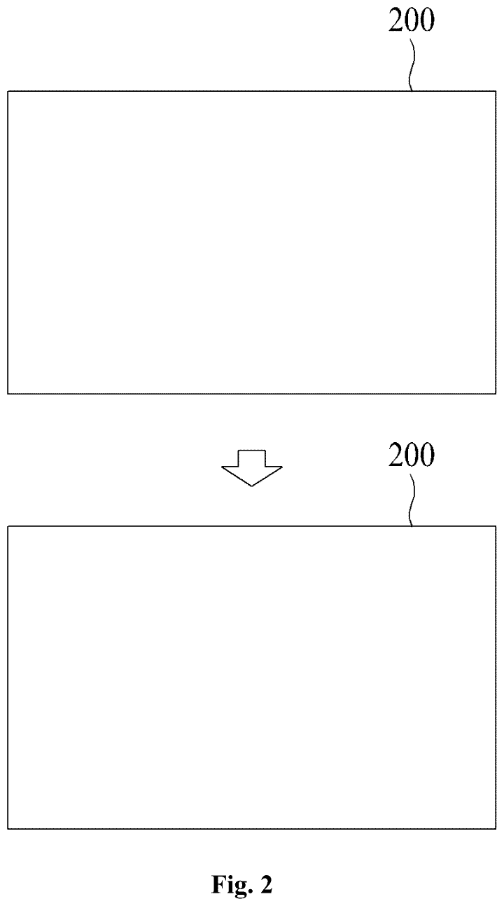

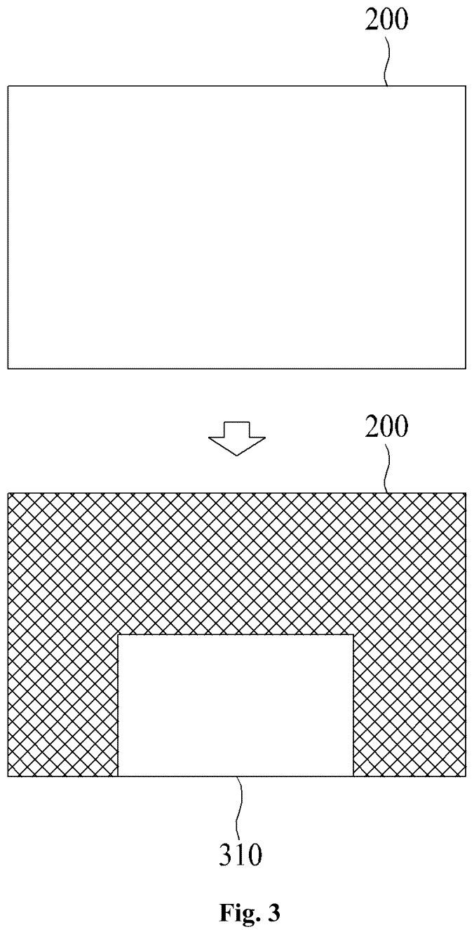

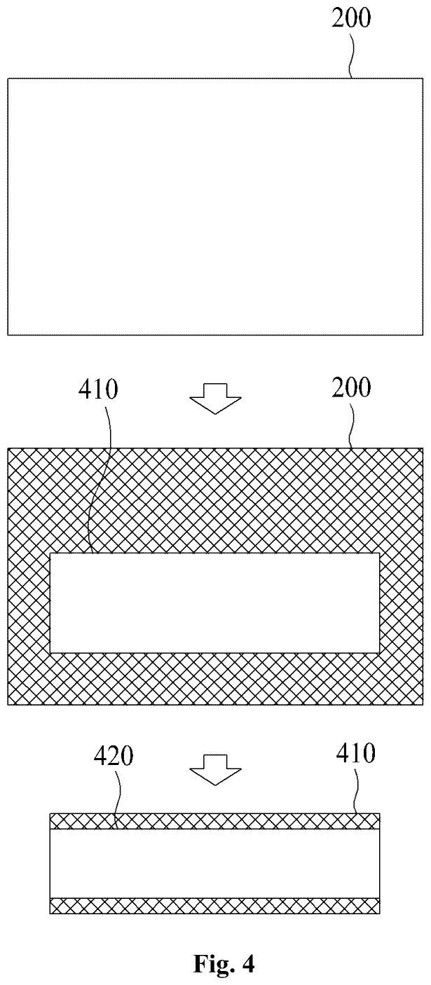

FIG. 1 is a block diagram illustrating a configuration of a image processing system 100 according to various example embodiments. FIG. 2 is an example diagram for explaining a first function of an electronic device 120 of FIG. 1. FIG. 3 is an example diagram for explaining a second function of the electronic device 120 of FIG. 1. FIG. 4 is an example diagram for explaining a third function of the electronic device 120 of FIG. 1.

Referring to FIG. 1, the image processing system 100 may be mounted to a vehicle and may include a plurality of camera devices 111, 113, and 115, and the electronic device 120. In some example embodiments, at least one another component may be added to the image processing system 100. The camera devices 111, 113, and 115 and the electronic device 120 may be communicatively connected in a wired or wireless manner. In an example embodiment, each of the camera devices 111, 113, and 115 may be connected to the electronic device 120 through a cable. In an example embodiment, each of the camera devices 111, 113, and 115 and the electronic device 120 may be connected through in-vehicle network communication (e.g., CAN communication). Each of the camera devices 111, 113, and 115 and the electronic device 120 may include various communication chips.

The camera devices 111, 113, and 115 may include at least one front camera device 111, at least one rear camera device 113, and at least two side camera devices 115. The front camera device 111 may be mounted on the front of the vehicle and may capture a front view image of the vehicle. In some example embodiments, when a plurality of front camera devices 111 are present, the front camera devices 111 may be provided for a common function or may be provided for different functions. For example, each of the front camera devices 111 may have the same lens property (e.g., angle of view, focal length, autofocus, f number, or optical zoom), or at least one front camera device 111 may have lens property different from that of other lenses. The front camera devices 111 may include a wide-angle lens or a telephoto lens. Also, the front camera devices 111 may have different shooting settings (e.g., day/night). However, it is not limited thereto.

The rear camera device 113 may be mounted on the rear of the vehicle and may capture a rear view image of the vehicle. In some example embodiments, when a plurality of rear camera devices 113 are present, the rear camera devices 113 may be provided for a common function or may be provided for different functions. For example, each of the rear camera devices 113 may have the same lens property (e.g., angle of view, focal length, autofocus, f number, or optical zoom), or at least one rear camera device 113 may have lens property different from that of other lenses. The rear camera devices 113 may include a wide-angle lens or a telephoto lens. Also, the rear camera devices 113 may have different shooting settings (e.g., day/night). However, it is not limited thereto.

The side camera devices 115 may be mounted on both sides of the vehicle and may capture side view images of the vehicle. Here, a single side camera device 115 or the plurality of side camera devices 115 may be mounted on each side of the vehicle.

The electronic device 120 may receive images from the camera devices 111, 113, and 115 and may use the images for various functions. In detail, the electronic device 120 may receive a front view image from the front camera device 111, may receive a rear view image from the rear camera device 113, and may receive side view images from the side camera devices 115. In particular, the electronic device 120 may receive a single rear view image 200 from the arbitrary rear camera device 113, and may use the rear view image 200 for the plurality of functions.

According to some example embodiments, the rear camera device 113 and the electronic device 120 may communicate with each other through a serial transmission scheme. In this case, the rear camera device 113 may include a serializer, and the electronic device 120 may include a deserializer. The serializer and the deserializer may perform bi-directional communication. Here, a first channel from the serializer to the deserializer and a second channel (, which may also be referred to as a back channel,) from the deserializer to the serializer may be present between the serializer and the deserializer. Through the first channel, the rear view image 200 may be transmitted. Here, the serializer may convert the rear view image 200 from parallel data to serial data, and the deserializer may convert the rear view image 200 from serial data to parallel data.

According to various example embodiments, the electronic device 120 may process the single rear view image 200 to a plurality of target images for a plurality of functions. The functions may include at least one of a digital video recording system (DVRS) function, an around view monitoring (AVM) function, and a digital rear view monitoring (DRM) function. In some example embodiments, the functions may further include at least one another function providable using the rear view image 200.

For the digital video recording system (DVRS) function of the first function, the electronic device 120 may store the rear view image 200 as a first target image. Here, a resolution of the first target image may be the same as that of the rear view image 200. For example, as shown in FIG. 2, the electronic device 120 may store the same image as the rear view image 200 captured from the rear camera device 113 as the first target image. Here, the electronic device 120 may acquire location information of the electronic device 120 in real time and may store the location information with the first target image. In some example embodiments, the electronic device 120 may also store at least one of the front view image and the side view images with the rear view image 200. Through this, the electronic device 120 may record a surrounding situation of the vehicle when the vehicle is in at least one state of driving, stopping, and parking. That is, the electronic device 120 may function as a digital image recording device. Here, a resolution of the first target image may be the same as that of the rear view image 200. A size of the first target image may be the same as that of the rear view image 200.

For the around view monitoring (AVM) function of the second function, the electronic device 120 may display a portion 310 of the rear view image 200 as a second target image that is a portion of an around view image of the vehicle. The electronic device 120 may convert the rear view image 200 captured from the rear camera device 113 to the second target image through image processing. For example, as shown in FIG. 3, the electronic device 120 may detect an area 310 in lower center of the rear view image 200 and may convert the detected area 310 to the second target image. The electronic device 120 may acquire the second target image by detecting the portion 310 present in a lower portion in a vertical direction and at the center in a horizontal direction in the rear view image 200 and by converting the detected portion 310 to the second target image. In more detail, the electronic device 120 may remove (crop) a remaining portion excluding the detected portion 310 in the rear view image 200 and may acquire only the detected portion as the second target image. Here, the electronic device 120 may perform image processing of detecting a lower central area of a corresponding image with respect to the front view image and the side view images. Accordingly, the electronic device 120 may combine the second target image and the image processed front view image and side view images and may display the same as the around view image. Here, a resolution of the second target image may be lower than that of the rear view image 200. A size of the second target image may differ from that of the rear view image 200. For example, the second target image may have a size less than that of the rear view image 200.

For the digital rear view monitoring (DRM) function of the third function, the electronic device 120 may display a portion 420 of the rear view image 200 on a digital rear mirror (DRM) (, which is described below,) as a third target image. The electronic device 120 may convert the rear view image 200 captured from the rear camera device 113 to the third target image through image processing. For example, as shown in FIG. 4, the electronic device 120 may detect a predetermined partial area 410 of the rear view image 200, and may convert one portion 420 of the detected area 410 to the third target image based on preset mirror variables. The third target image may be displayed on the digital rear mirror. In detail, the electronic device 120 may remove (crop) a remaining portion excluding the detected area 410 in the rear view image 200 and then may detect the portion 420 within the detected area 410 based on the mirror variables. Here, the mirror variables are used to determine an angle of view secured through the digital rear mirror and may include at least one of a size and a location of the portion 420 in the detected area 410. The mirror variables may be adjusted based on a user input for changing the angle of view (, which may indicate a tilt,) corresponding to a viewing angle desired by a user. The electronic device 120 may acquire the third target image by tuning the detected portion 420. Here, the electronic device 120 may at least partially enlarge the detected portion 420. Accordingly, the electronic device 120 may provide the unobstructed rear visual field to the user, that is, a driver of the vehicle through the digital rear mirror. Here, a resolution of the third target image may be less than that of the rear view image 200. A size of the third target image may differ from that of the rear view image 200. For example, the third target image may have a size less than that of the rear view image 200.

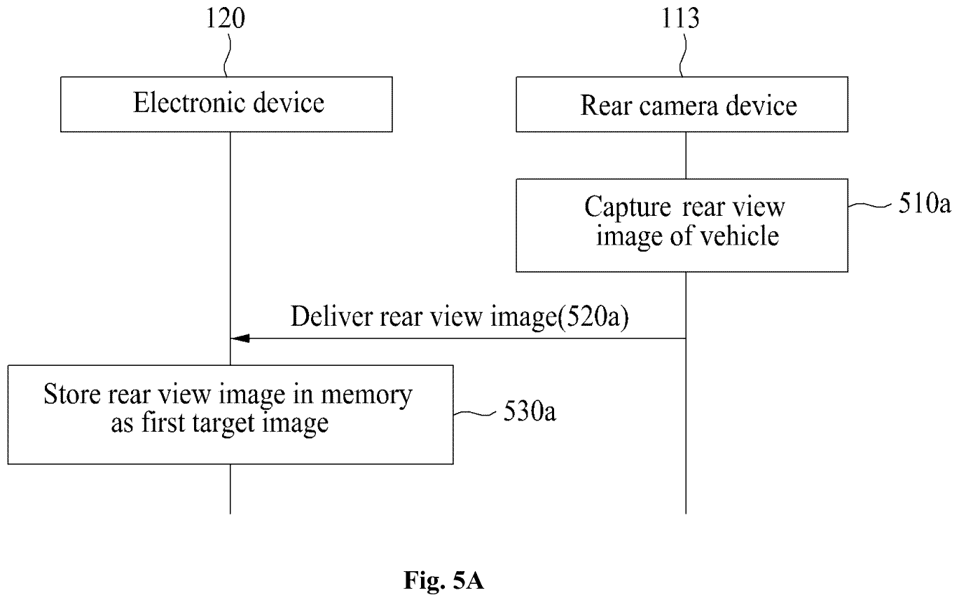

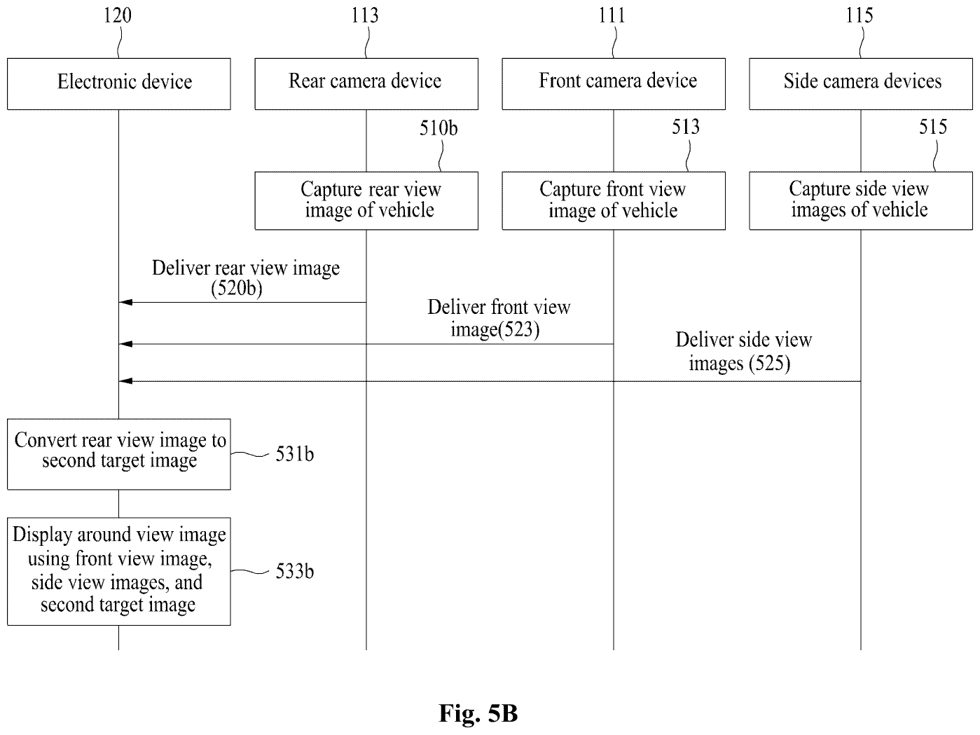

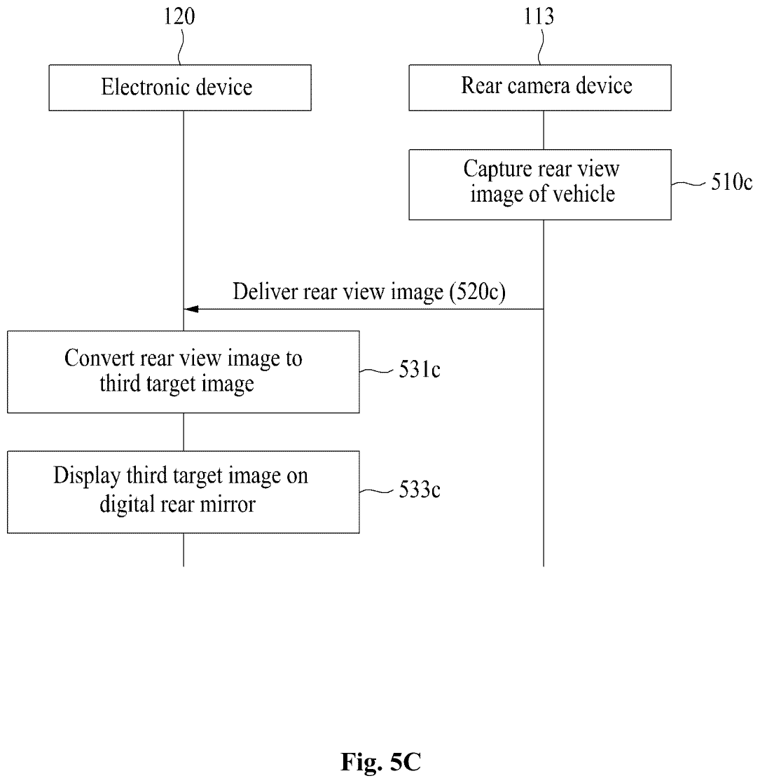

FIGS. 5A, 5B, and 5C are flowcharts illustrating an operating method of the image processing system 100 according to various example embodiments. FIG. 5A is a flowchart illustrating a image processing operation for providing a digital video recording system (DVRS) function according to an example embodiment. FIG. 5B is a flowchart illustrating a image processing operation for providing an around view monitoring (AVM) function according to an example embodiment. FIG. 5C is a flowchart illustrating a image processing operation for providing a digital rear view monitoring (DRM) function according to an example embodiment. Here, the electronic device 120 may process the rear view image 200 to a plurality of target images for a plurality of functions. The functions may include at least one of the digital video recording system (DVRS) function, the around view monitoring (AVM) function, and the digital rear view monitoring (DRM) function. In some example embodiments, the functions may further include at least one other function providable using the rear view image 200. Referring to FIG. 5A, in operation 510a, the rear camera device 113 may capture the rear view image 200 of the vehicle. Here, the rear view image 200 may have an arbitrary resolution. For example, a reference resolution of the rear view image 200 may represent a quad high definition (QHD) resolution (e.g., 2560×1440 pixels). In operation 520a, the rear camera device 113 may deliver the rear view image 200 to the electronic device 120. Through this, the electronic device 120 may receive the rear view image 200 from the rear camera device 113.

In operation 530a, the electronic device 120 may provide the image processing operation for providing the digital video recording system (DVRS) function using the rear view image 200. In detail, for the digital video recording system (DVRS) function of the first function, the electronic device 120 may store the rear view image 200 in a memory as a first target image. For example, the electronic device 120 may convert the same image as the rear view image 200 to the first target image. Here, a resolution of the first target image may be the same as a reference resolution (2560×1440 pixels) of the rear view image 200. A size of the first target image may be the same as that of the rear view image 200. The electronic device 120 may store the first target image having the same resolution and size as those of the rear view image 200 in the memory.

Referring to FIG. 5B, in operation 510b, the rear camera device 113 may capture the rear view image 200 of the vehicle. Here, the rear view image 200 may have an arbitrary resolution. For example, a reference resolution of the rear view image 200 may represent a QHD resolution (e.g., 2560×1440 pixels). Meanwhile, in operation 513, the front camera device 111 may capture a front view image of the vehicle. In operation 515, the side camera devices 115 may capture side view images of the vehicle, respectively. Here, operations 510b, 513, and 515 may be simultaneously or substantially simultaneously performed. In operation 520b, the rear camera device 113 may deliver the rear view image 200 to the electronic device 120. Meanwhile, in operation 523, the front camera device 111 may deliver the front view image to the electronic device 120. In operation 525, the side camera devices 115 may deliver the side view images to the electronic device 120, respectively. Through this, the electronic device 120 may receive the rear view image 200, the front view image, and the side view images from the rear camera device 113, the front camera device 111, and the side camera devices 115, respectively.

In operations 531b and 533b, the electronic device 120 may perform the image processing operation for providing the around view monitoring (AVM) function using the rear view image 200. In detail, in operation 531b, the electronic device 120 may convert the rear view image 200 to the second target image. That is, the electronic device 120 may acquire the portion 310 of the rear view image 200 as the second target image that is a portion of an around view image of the vehicle. The electronic device 120 may acquire the second target image by performing down-scaling on the rear view image 200. Based on the fact that the electronic device 120 performs down-scaling, a resolution of the second target image may be less than the reference resolution of the rear view image 200 and a size of the second target image is less than that of the rear view image 200. For example, the resolution of the second target image may represent a high definition (HD) resolution (e.g., 1280×720 pixels). In some example embodiments, the electronic device 120 may perform image process of detecting a lower central area of a corresponding image by performing down-scaling on at least one of the front view image and the side view images. In operation 533b, the electronic device 120 may display the around view image using the second target image, the front view image, and the side view images. Here, the electronic device 120 may generate the around view image by combining the second target image, the front view image, and the side view images.

Referring to FIG. 5C, in operation 510c, the rear camera device 113 may capture the rear view image 200 of the vehicle. Here, the rear view image 200 may have an arbitrary resolution. For example, a reference resolution of the rear view image 200 may represent a QHD resolution (e.g., 2560×1440 pixels). In operation 520c, the rear camera device 113 may deliver the rear view image 200 to the electronic device 120. Through this, the electronic device 120 may receive the rear view image 200 from the rear camera device 113.

In operations 531c and 533c, the electronic device 120 may perform the image processing operation for providing the digital rear view monitoring (DRM) function using the rear view image 200. In detail, in operation 531c, the electronic device 120 may acquire the portion 420 of the rear view image 200 as a third target image. The electronic device 120 may acquire the third target image by performing down-scaling on the rear view image 200. Based on the fact that the electronic device 120 performs down-scaling, a resolution of the third target image may be less than that of the rear view image 200, and a size of the third target image may be less than that of the rear view image 200. For example, the resolution of the third target image may represent a full high definition (FHD) resolution (e.g., 1920×384 pixels). Then, in operation 533c, the electronic device 120 may display the third target image on a digital rear mirror.

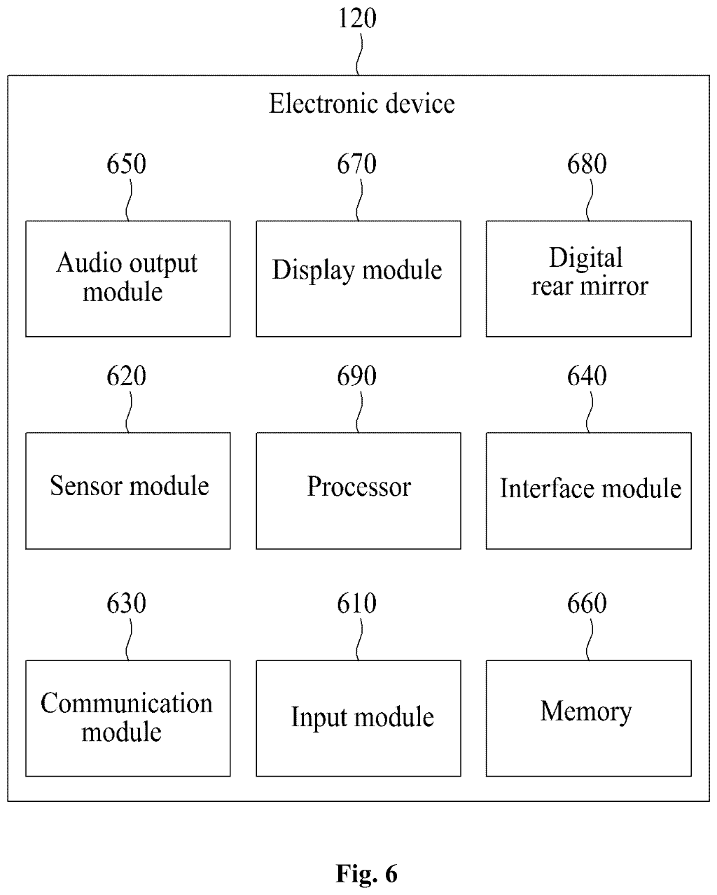

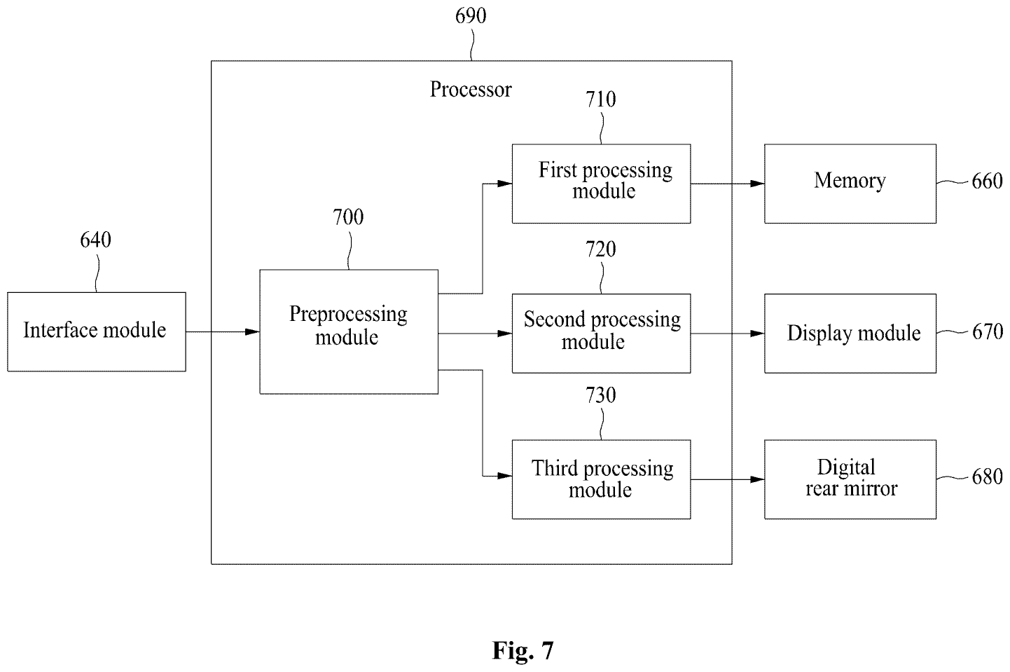

FIG. 6 is a block diagram illustrating an internal configuration of the electronic device 120. FIG. 7 is a block diagram illustrating a configuration of a processor 690 of FIG. 6.

Referring to FIG. 6, the electronic device 120 may be mounted to a vehicle with the camera devices 111, 113, and 115, and may be communicatively connected to the camera devices 111, 113, and 115. In detail, the electronic device 120 may include at least one of an input module 610, a sensor module 620, a communication module 630, an interface module 640, an audio output module 650, a memory 660, a display module 670, a digital rear mirror 680, and the processor 690. In some example embodiments, at least one of the components of the electronic device 120 may be omitted, and at least one another component may be added. In some example embodiments, at least two of the components of the electronic device 120 may be implemented as a single integrated circuit.

The input module 610 may input a signal to be used for at least one component of the electronic device 120. For example, the input module 610 may include at least one of a key, a button, a keyboard, a keypad, a mouse, a joystick, and a microphone. In some example embodiments, the input module 610 may include at least one of a touch circuitry configured to detect a touch and a sensor circuitry configured to measure strength of force generated by touch.

The sensor module 620 may generate an electrical signal or a data value corresponding to an internal operation state (e.g., power or temperature) or an external environmental state of the electronic device 120. For example, the sensor module 620 may include at least one of a radar sensor, a light detection and ranging (LIDAR) sensor, a motion sensor, a gesture sensor, a gyro sensor, a barometric pressure sensor, a magnetic sensor, an acceleration sensor, a grip sensor, a proximity sensor, a color sensor, an infrared (IR) sensor, a biosignal sensor, a temperature sensor, a humidity sensor, and an illuminance sensor.

The communication module 630 may communicate with an external device. The communication module 630 may establish a communication channel between the electronic device 120 and the external device and may communicate with the external device through the communication channel. Here, the external device may include at least one of a satellite, a base station, a server, and another electronic device. The communication module 630 may include at least one of a wired communication module and a wireless communication module. The wired communication module may be connected to the external device in a wired manner and may communicate with the external device in the wired manner through a connection terminal. The wireless communication module may include at least one of a near field communication module and a far field communication module. The near field communication module may communicate with the external device using a near field communication scheme. For example, the near field communication scheme may include at least one of Bluetooth, wireless fidelity (WiFi) direct, and infrared data association (IrDA). The far field communication module may communicate with the external device using a far field communication scheme. Here, the far field communication module may communicate with the external device over a network. For example, the network may include at least one of a cellular network, the Internet, and a computer network such as a local area network (LAN) and a wide area network (WAN).

According to various example embodiments, at least one of the input module 610, the sensor module 620, and the communication module 630 may generate a user input. In an example embodiment, the input module 610 or an arbitrary sensor of the sensor module 620 may generate the user input based on a signal that is directly input from the user. For example, the input module 610 may generate the user input based on at least one of key (e.g., hard key or soft key) input or voice input. For example, the motion sensor, the gesture sensor, the proximity sensor, the temperature sensor, or the illuminance sensor of the sensor module 620 may generate the user input based on a change in an external environmental state. In another example embodiment, the communication module 630 may generate the user input based on a signal that is input from another electronic device used by the user.

The interface module 640 may be provided for connection to the external device. In detail, the interface module 640 may support a designated protocol connectable to the external device in a wired or wireless manner. Here, the external device may include the camera devices 111, 113, and 115. For example, the interface module 640 may include at least one of an HDMI, a USB interface, an SD card interface, and an audio interface.

The audio output module 650 may output an audio signal. For example, the audio output module 650 may include at least one of a speaker and a receiver.

The memory 660 may store a variety of data used by at least one component of the electronic device 120. For example, the memory 660 may include at least one of a volatile memory and a non-volatile memory. Data may include at least one program and input data or output data related thereto. The program may be stored in the memory 660 as software including at least one instruction, and for example, may include at least one of an operating system (OS), middleware, and application. According to various example embodiments, the memory 660 may store programs for a plurality of functions. According to various example embodiments, the memory 660 may store a first target image.

The display module 670 may display information. Here, the display module 670 may be provided around a driver's seat, for example, a dashboard of the vehicle such that the driver of the vehicle may verify information from the driver's seat. For example, the display module 670 may include at least one of a display, a hologram device, and a projector. For example, the display module 670 may be implemented as a touchscreen by being assembled with at least one of the touch circuitry and the sensor circuitry of the input module 610. According to various example embodiments, the display module 670 may display a second target image.

The digital rear mirror 680 may provide a rear visual field of the vehicle. To this end, the digital rear mirror 680 may be provided within the driver's field of view. Here, the digital rear mirror 680 may be provided in front of the driver's seat such that the driver of the vehicle may verify the rear visual field of the vehicle from the driver's seat. In detail, the digital rear mirror 680 may be provided at a location of a typical rear mirror. For example, the digital rear mirror 680 may include at least one of a display, a hologram device, and a projector. For example, the digital rear mirror 680 may be implemented as a touchscreen by being assembled with at least one of the touch circuitry and the sensor circuitry of the input module 610. According to various example embodiments, the digital rear mirror 680 may display a third target image.

The processor 690 may control at least one component of the electronic device 120 by executing the program of the memory 660. Through this, the processor 690 may perform data processing or operation. Here, the processor 690 may execute an instruction stored in the memory 660. According to various example embodiments, the processor 690 may receive images from the camera devices 111, 113, and 115, and may use the images for various functions. In particular, the processor 690 may receive the single rear view image 200 from arbitrary rear camera device 113 and may use the rear view image 200 for the plurality of functions. That is, the processor 690 may process the rear view image 200 to a plurality of target images for the plurality of functions. The functions may include at least one of a digital video recording system (DVRS) function, an around view monitoring (AVM) function, and a digital rear view monitoring (DRM) function. In some example embodiments, the functions may further include at least one another function providable using the rear view image 200.

According to various example embodiments, referring to FIG. 7, the processor 690 may include a preprocessing module 700 and a plurality of processing modules 710, 720, and 730. Here, each of the processing modules 710, 720, and 730 may be provided for each of functions providable using the rear view image 200. In some example embodiments, the number of the processing modules 710, 720, and 730 may be configured to be fewer or more depending on the number of functions.

The preprocessing module 700 may duplicate the single rear view image 200 and generate the plurality of rear view images 200. In detail, the preprocessing module 700 may receive the rear view image 200 from the rear camera device 113 through the interface module 640. The module 700 may duplicate the rear view image 200 and may generate the number of rear view images 200 corresponding to the number of processing modules 710, 720, and 730. In some example embodiments, the interface module 640 or the preprocessing module 700 may include a deserializer. In an example embodiment, after the deserializer converts the rear view image 200 from serial data to parallel data, the preprocessing module 700 may duplicate the rear view image 200. In another example embodiment, after the preprocessing module 700 generates the rear view images 200, the deserializer may convert the rear view images 200 from serial data to parallel data. Through this, the preprocessing module 700 may provide the rear view images 200 to the processing modules 710, 720, and 730, respectively.

The processing modules 710, 720, and 730 may receive the rear view images 200 from the preprocessing module 700, respectively, and may process the rear view images 200 to target images according to functions, respectively. The processing modules 710, 720, and 730 may include the first processing module 710 for a digital video recording system (DVRS) function, the second processing module 720 for an around view monitoring (AVM) function, and the third processing module 730 for the digital rear view monitoring (DRM) function.

The first processing module 710 may be provided for the digital video recording system (DVRS) function, and may store the rear view image 200 in the memory 660 as the first target image. Here, a resolution of the first target image may be the same as that of the rear view image 200. For example, the resolution of the first target image may represent a QHD resolution (2560*1440 pixels). In detail, as shown in FIG. 2, the first processing module 710 may store the same image as the rear view image 200 as the first target image. Here, the processor 690 may acquire location information of the electronic device 120 in real time, and the first processing module 710 may store the location information in the memory 660 with the first target image. In an example embodiment, the processor 690 may receive the location information through the communication module 630, and the location information may include global navigation satellite system (GNSS) information. For example, the GNSS information may include global positioning system (GPS) information. In some example embodiments, the first processing module 710 may store at least one of a front view image and side view images with the rear view image 200. Through this, the first processing module 710 may record a surrounding situation of the vehicle when the vehicle is in at least one state of driving, stopping, and parking. That is, the electronic device 120 may function as a digital image recording device.

The second processing module 720 may be provided for the around view monitoring (AVM) function of the second function, and may display the portion 310 of the rear view image 200 on the display module 670 as the second target image that is a portion of an around view image of the vehicle. Here, a resolution of the second target image may be lower than that of the rear view image 200. For example, the resolution of the second target image may represent an HD resolution (e.g., 1280×720 pixels). In detail, as shown in FIG. 3, the second processing module 720 may detect the portion 310 that is present at a lower center of the rear view image 200, may convert the detected portion 310 to the second target image, and may display the second target image. In detail, the second processing module 720 may crop the detected portion 310 in the rear view image 200 to remove a remaining portion, and may acquire the second target image by tuning the detected portion 310 toward, for example, the ground. Here, the second processing module 720 may tune the front view image and the side view images toward the floor, for example, the ground. Accordingly, the second processing module 720 may combine the second target image and the tuned front view image and side view images and may display the same on the display module 670 as an around view image.

The third processing module 730 may be provided for the digital rear view monitoring (DRM) function of the third function and may display the portion 420 of the rear view image 200 on the digital rear mirror 680 as the third target image. Here, a resolution of the third target image may be lower than that of the rear view image 200. For example, the resolution of the third target image may represent an FHD resolution (e.g., 1920×384 pixels). In detail, as shown in FIG. 4, the third processing module 730 may detect the predetermined partial area 410 of the rear view image 200, may convert the portion 420 of the detected area 410 to the third target image based on preset mirror variables, and may display the third target image on the digital rear mirror 680. In more detail, the third processing module 730 may crop the detected area 410 in the rear view image 200 to remove a remaining area and then may detect the portion 410 within the detected area 410 based on the mirror variables. Here, the mirror variables relate to determining an angle of view secured through the digital rear mirror 680 and may include at least one of a size and a location of the portion 420 in the detected area 410. The mirror variables may be adjusted based on a user input for changing the angle of view (,which may indicate a tilt,) corresponding to a viewing angle desired by the user. The third processing module 730 may acquire the third target image by tuning the detected portion 420. Here, the third processing module 730 may at least partially enlarge the detected portion 420. For example, the third processing module 730 may resize the detected portion 420 in response to a display area of the digital rear mirror 680. Accordingly, the third processing module 730 may provide the unobstructed rear visual field to the user, that is, the driver of the vehicle through the digital rear mirror 680.

Additionally, the third processing module 730 may detect reference information by analyzing the rear view image 200 and may display the reference information on the digital rear mirror 680 with the third target image. The reference information may be information within the rear view image 200, for example, a road sign, and may be information derived from the rear view image 200, for example, a distance from an adjacent vehicle and a speed of the adjacent vehicle. Here, the reference information may be displayed using various graphical representations, for example, text, symbol, and image.

Additionally, the third processing module 730 may adjust the digital rear mirror 680 using a sensing input that is input through the sensor module 620. For example, the third processing module 730 may detect the sensing input indicating ambient brightness, input through the illuminance sensor. In this case, the third processing module 730 may change at least one of the brightness and reflectance of the digital rear mirror 680 using the sensing input.

In an example embodiment, the processor 690 may include a central processing unit (CPU). In this case, the processing modules 710, 720, and 730 may be implemented functionally separate within the CPU. In another example embodiment, when the digital rear mirror 680 is implemented as a display, the processor 690 may also include not only the CPU but also a display controller (e.g., liquid crystal display (LCD) controller when the digital rear mirror 680 includes (LCD). In this case, the third processing module 730 may be implemented by being integrated with the display controller or may be implemented separate from the display controller.

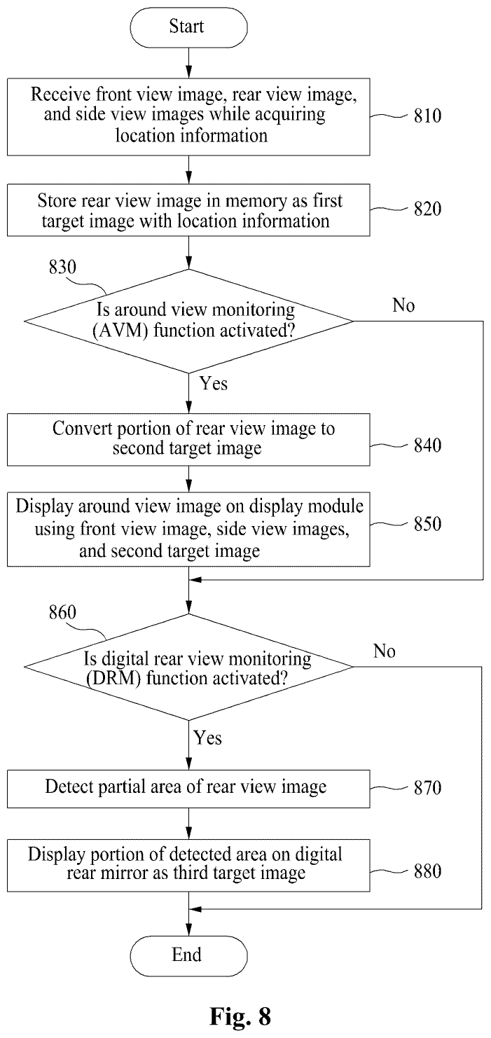

FIG. 8 is a flowchart illustrating an operating method of the electronic device 120 according to various example embodiments.

Referring to FIG. 8, in operation 810, the electronic device 120 may receive the front view image, the rear view image 200, and the side view images while acquiring location information. In detail, the processor 690 may acquire location information of the electronic device 120 in real time. In an example embodiment, the processor 690 may receive the location information through the communication module 630, and the location information may include GNSS information. For example, the GNSS information may include GPS information. In addition, the processor 690 may receive the front view image, the rear view image 200, and the side view images of the vehicle from the front camera device 111, the rear camera device 113, and the side camera devices 115 through the interface module 640, respectively. In particular, the processor 690 may receive the single rear view image 200. For example, a resolution of the rear view image 200 may represent a QHD resolution (2560×1440 pixels). Here, in the processor 690, the preprocessing module 700 may duplicate the rear view image 200, and generate the plurality of rear view images 200.

In operation 820, the electronic device 120 may use the rear view image 200 for the digital video recording system (DVRS) function. That is, the processor 690 may store the rear view image 200 in the memory 660 as a first target image along with the location information. Here, a resolution of the first target image may be the same as that of the rear view image 200. For example, the resolution of the first target image may represent the QHD resolution (2560×1440 pixels). A size of the first target image may be the same as that of the rear view image 200. In detail, in the processor 690, the first processing module 710 may store the same image as the rear view image 200 as the first target image with the location information as shown in FIG. 2. In some example embodiments, the first processing module 710 may store at least one of the front view image and the side view images with the rear view image 200. For example, a resolution of at least one of the front view image and the side view images may be the same as that of the rear view image 200. In this case, the first processing module 710 may store at least one of the front view image and the side view images with the rear view image 200. Through this, the first processing module 710 may record a surrounding situation of the vehicle when the vehicle is in at least one state of driving, stopping, and parking. That is, the electronic device 120 may function as a digital image recording device.

In operation 830, the electronic device 120 may verify whether the around view monitoring (AVM) function is activated. Here, the processor 690 may activate or inactivate the around view monitoring (AVM) function based on a user input. That is, the processor 690 may activate the around view monitoring (AVM) function in response to the user input, and may maintain the same until a user input for inactivating the around view monitoring (AVM) function is detected. When the around view monitoring (AVM) function is activated in operation 830, the electronic device 120 may use the rear view image 200 for the around view monitoring (AVM) function in operations 840 and 850.

In operation 840, the electronic device 120 may convert the portion 310 of the rear view image 200 to a second target image that is a portion of the around view image of the vehicle. Here, a resolution of the second target image may be less than that of the rear view image 200. For example, the resolution of the second target image may represent an HD resolution (e.g., 1280×720 pixels). A size of the second target image may be less than that of the rear view image 200. In detail, in the processor 690, as shown in FIG. 3, the second processing module 720 may detect the portion 310 present in lower center of the rear view image 200 and may convert the detected portion 310 to the second target image. In detail, the second processing module 720 may remove a remaining portion by cropping the detected portion 310 in the rear view image 200 and may acquire the second target image by tuning the detected portion 310 toward the floor, for example, the ground.

In operation 850, the electronic device 120 may display the around view image on the display module 670 using the front view image, the side view images, and the second target image. In detail, in the processor 690, the second processing module 720 may generate the around view image by combining the second target image and the front view image and the side view images and may display the around view image on the display module 670. In some example embodiments, resolutions of the front view image and the side view images may be the same as that of the second target image. In this case, the second processing module 720 may tune the front view image and the side view images toward the floor, for example, the ground and then combine the second target image and the tuned front view image and side view images.

Meanwhile, in operation 860, the electronic device 120 may determine whether the digital rear view monitoring (DRM) function is activated. Here, the processor 690 may activate or inactivate the digital rear view monitoring (DRM) function based on the user input. That is, the processor 690 may activate the digital rear view monitoring (DRM) function in response to the user input, and may maintain the same until a user input for inactivating the digital rear view monitoring (DRM) function is detected. If the digital rear view monitoring (DRM) function is activated in operation 860, the electronic device 120 may use the rear view image 200 for the digital rear view monitoring (DRM) function in operations 870 and 880.

Initially, in operation 870, the electronic device 120 may detect the portion 410 of the rear view image 200. In detail, as shown in FIG. 4, in the processor 690, the third processing module 730 may detect the predetermined partial area 410 of the rear view image 200. For example, the third processing module 730 may detect the partial area 410 present in a lower portion in a vertical direction and at the center in a horizontal direction in the rear view image 200. Here, a resolution of the detected area 410 may be less than that of the rear view image 200. For example, the resolution of the detected area 410 may represent an FHD resolution (e.g., 1920×600 pixels). In more detail, the third processing module 730 may remove a remaining area by cropping the detected area 410 in the rear view image 200.

In operation 880, the electronic device 120 may display the portion 420 of the detected area 410 on the digital rear mirror 680 as a third target image. Here, a resolution of the third target image may be less than that of the rear view image 200. For example, the resolution of the third target image may represent the FHD resolution (e.g., 1920×384 pixels). A size of the third target image may be less than that of the rear view image 200. In detail, as shown in FIG. 4, in the processor 690, the third processing module 730 may convert the portion 420 of the detected area 410 to the third target image based on preset mirror variables and may display the third target image on the digital rear mirror 680. In detail, the third processing module 730 may detect the portion 420 within the detected area 410 based on the mirror variables. Here, the mirror variables are used to determine an angle of view secured through the digital rear mirror 680 and may include at least one of a size and a location of the portion 420 in the detected area 410. The mirror variables may be adjusted based on a user input for changing the angle of view (, which may indicate a tilt,) corresponding to a viewing angle desired by the user. The third processing module 730 may acquire the third target image by tuning the detected portion 420. Here, the third processing module 730 may enlarge at least partially the detected portion 420. For example, the third processing module 730 may resize the detected portion 420 to correspond to a display area of the digital rear mirror 680.

In this manner, the electronic device 120 may perform at least one of the digital video recording system (DVRS) function, the around view monitoring (AVM) function, and the digital rear view monitoring (DRM) function. In detail, if the around view monitoring (AVM) function is not activated in operation 830 and the digital rear view monitoring (DRM) function is not activated in operation 860, the electronic device 120 may basically perform only the digital video recording system (DVRS) function. Meanwhile, if the around view monitoring (AVM) function is not activated in operation 830 and the digital rear view monitoring (DRM) function is activated in operation 860, the electronic device 120 may perform the digital video recording system (DVRS) function and the digital rear view monitoring (DRM) function. Here, the digital video recording system (DVRS) function and the digital rear view monitoring (DRM) function may be substantially simultaneously performed. Meanwhile, if the around view monitoring (AVM) function is activated in operation 830 and the digital rear view monitoring (DRM) function is not activated in operation 860, the electronic device 120 may perform the digital video recording system (DVRS) function and the around view monitoring (AVM) function. Here, the digital video recording system (DVRS) function and the around view monitoring (AVM) function may be substantially simultaneously performed. Meanwhile, if the around view monitoring (AVM) function is activated in operation 830 and the digital rear view monitoring (DRM) function is activated in operation 860, the electronic device 120 may perform the digital video recording system (DVRS) function, the around view monitoring (AVM) function, and the digital rear view monitoring (DRM) function. Here, the digital video recording system (DVRS) function, around view monitoring (AVM) function, and digital rear view monitoring (DRM) function may be substantially simultaneously performed.

According to example embodiments, the electronic device 120 may perform an integrated multi-function using the single rear view image 200 of the vehicle. That is, the electronic device 120 may process the rear view image 200 to a plurality of target images for the plurality of functions. The functions may include at least one of the digital video recording system (DVRS) function, the around view monitoring (AVM) function, and the digital rear view monitoring (DRM) function. Accordingly, since only one rear camera device 113 may be installed in the vehicle, the number of camera devices 111, 113, and 115 may be reduced. This may lead to a decrease in the number of hours of work used to install the camera devices 111, 113, and 115 in the vehicle, a decrease in installation cost due to unit cost of the camera devices 111, 113, and 115 and cables, and a decrease in the weight of the vehicle in which the camera devices 111, 113, and 115 are installed.

In short, the example embodiments herein provide the electronic device 120 for performing an integrated multi-function using the single rear view image 200 of a vehicle and an operating method thereof.

Herein, the electronic device 120 is connected to the camera device 113 that captures the rear view image 200 of the vehicle and may include the interface module 640 configured to communicatively connect to the camera device 113 and the processor 690 configured to connect to the interface module 640 and to process the rear view image 200 received through the interface module 640 to a plurality of target images for a plurality of functions.

According to various example embodiments, the electronic device 120 may further include the memory 660 configured to connect to the processor 690, and the processor 690 may be configured to store the rear view image 200 in the memory 660 as a first target image.

According to various example embodiments, the electronic device 120 may further include a communication module 630 configured to connect to the processor 690, and the processor 690 may be configured to acquire location information through the communication module 630 and to store the location information in the memory 660 with the first target image.

According to various example embodiments, a resolution of the first target image (e.g., QHD) may be the same as that of the rear view image 200 (e.g., QHD), and a resolution of at least one of the target images (e.g., HD or FHD) may be less than that of the rear view image 200.

According to various example embodiments, the electronic device 120 may further include the display module 670 connected to the processor 690, and the processor 690 may be configured to display the portion 310 of the rear view image 200 on the display module 670 as a second target image second target image that is a portion of an around view image around the vehicle.

According to various example embodiments, the processor 690 may be configured to detect the lower central portion 310 of the rear view image 200, to convert the detected portion 310 to the second target image, and to display the second target image on the display module 670.

According to various example embodiments, the electronic device 120 may further include the digital rear mirror 680 configured to connect to the processor 690, and the processor 690 may be configured to display the portion 420 of the rear view image 200 on the digital rear mirror 680 as a third target image.

According to various example embodiments, the processor 690 may be configured to detect the predetermined partial area 410 of the rear view image 200, to convert the portion 420 of the detected area 410 to the third target image based on preset mirror variables, and to display the third target image on the digital rear mirror 680.

According to various example embodiments, the processor 690 may be configured to acquire the third target image by detecting the portion 420 of the detected area 410 and by at least partially enlarging the detected portion 420.

According to various example embodiments, the mirror variables may include at least one of a size and a location of the portion 420 in the detected area 410, and the processor 690 may be configured to adjust at least one of the size or the location based on a user input.

According to various example embodiments, the processor 690 may include the preprocessing module 700 configured to duplicate the rear view image 200 and to generate the plurality of rear view images 200, and the plurality of processing modules 710, 720, and 730 assigned with the functions, respectively, and configured to receive the rear view images 200, respectively, and to process the rear view images 200 to the target images according to the functions, respectively.

Herein, an operating method of the electronic device 120 may include receiving the rear view image 200 of the vehicle from the camera device 113 (operation 810), and processing the rear view image 200 to a plurality of target images for a plurality of functions (operation 820, operations 840 and 850, operations 870 and 880).

According to various example embodiments, the processing to the target images (operation 820, operations 840 and 850, operations 870 and 880) may include storing the rear view image 200 in the memory 660 as a first target image (operation 820).

According to various example embodiments, the operating method of the electronic device 120 may further include acquiring location information of the electronic device 120, and the storing in the memory 660 (operation 820) may include storing the location information in the memory 660 with the first target image.

According to various example embodiments, a resolution (e.g., QHD) of the first target image may be the same as that (e.g., QHD) of the rear view image 200, and a resolution (e.g., HD or FHD) of at least other one of the target images may be less than that of the rear view image 200.

According to various example embodiments, the processing to the target images (operation 820, operations 840 and 850, operations 870 and 880) may include displaying the portion 310 of the rear view image 200 on the display module 670 as a second target image that is a portion of an around view image around the vehicle (operations 840 and 850).

According to various example embodiments, the displaying on the display module 670 (operations 840 and 850) may include detecting a lower central portion of the rear view image 200 (operation 840), converting the detected portion to the second target image (operation 840), and displaying the second target image on the display module 670 (operation 850).

According to various example embodiments, the processing to the target images (operation 820, operations 840 and 850, operations 870 and 880) may include displaying the portion 420 of the rear view image 200 on the digital rear mirror 680 as a third target image (operations 870 and 880).

According to various example embodiments, the displaying on the digital rear mirror 680 (operations 870 and 880) may include detecting the predetermined partial area 410 of the rear view image 200 (operation 870), converting the one portion 410 of the detected area 410 to the third target image based on preset mirror variables (operation 880), and displaying the third target image on the digital rear mirror 680 (operation 880).

According to various example embodiments, the converting to the third target image (operation 880) may include acquiring the third target image by detecting the portion 420 of the detected area 410 and by at least partially enlarging the detected portion 420.

According to various example embodiments, the mirror variables may include at least one of a size and a location of the portion 420 in the detected area 410, and at least one of the size and the location may be adjusted based on a user input.

According to various example embodiments, the processing to the target images (operation 820, operations 840 and 850, operations 870 and 880) may include duplicating the rear view image 200 and generating the plurality of rear view images 200, and processing the rear view images 200 to the target images according to the functions, respectively.

Herein, the image processing system 100 may include the camera device 113 configured to capture the rear view image 200 of the vehicle, and the electronic device 120 configured to process the rear view image 200 to a plurality of target images for a plurality of functions.

According to various example embodiments, the electronic device 120 may include the memory 660, and may be configured to store the rear view image 200 in the memory 660 as a first target image.

According to various example embodiments, the electronic device 120 may include the display module 670, and may be configured to display a portion of the rear view image 200 on the display module 670 as a second target image that is a portion of an around view image around the vehicle.

According to various example embodiments, the electronic device 120 may include the digital rear mirror 680, and may be configured to display a portion of the rear view image 200 on the digital rear mirror 680 as a third target image.

Herein, an operating method of the image processing system 100 may include capturing, by the camera device 113, the rear view image 200 of the vehicle (operation 510a, operation 510b, operation 510c), and processing, by the electronic device 120, the rear view image 200 to a plurality of target images for a plurality of functions (operation 530a, operations 531b and 533b, operations 531c and 533c).

According to various example embodiments, the electronic device 120 may include the memory 660, and the processing to the target images (operation 530a, operations 531b and 533b, operations 531c and 533c) may include storing the rear view image 200 in the memory 660 as a first target image (operation 530a).

According to various example embodiments, the electronic device 120 may include the display module 670, and the processing to the target images (operation 530a, operations 531b and 533b, operations 531c and 533c) may include displaying a portion of the rear view image 200 on the display module 670 as a second target image that is a portion of an around view image around the vehicle (operations 531b and 533b).

According to various example embodiments, the electronic device 120 may include the digital rear mirror 680, and the processing to the target images (operation 530a, operations 531b and 533b, operations 531c and 533c) may include a portion of the rear view image 200 on the digital rear mirror 680 as a third target image (operations 531c and 533c).

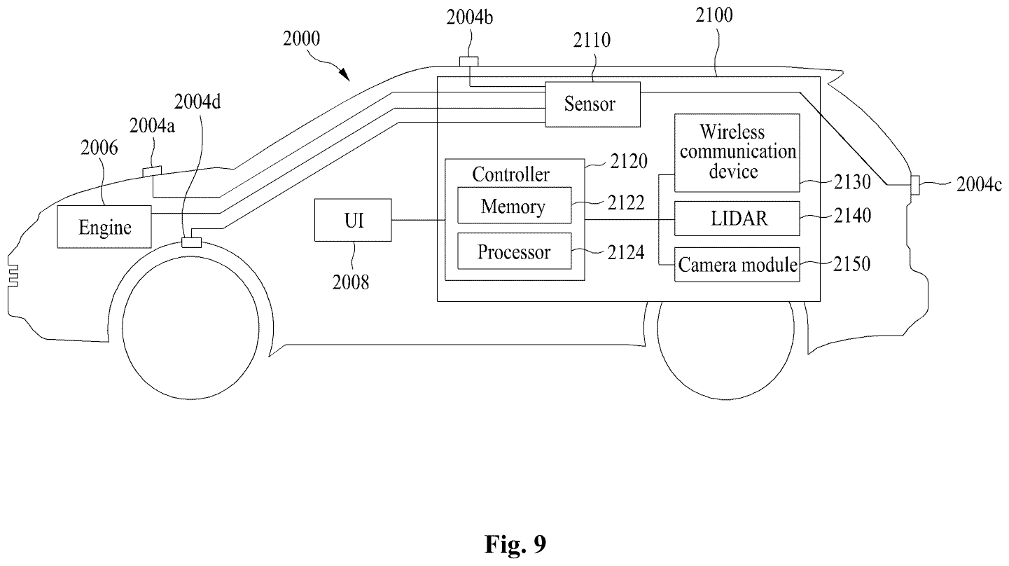

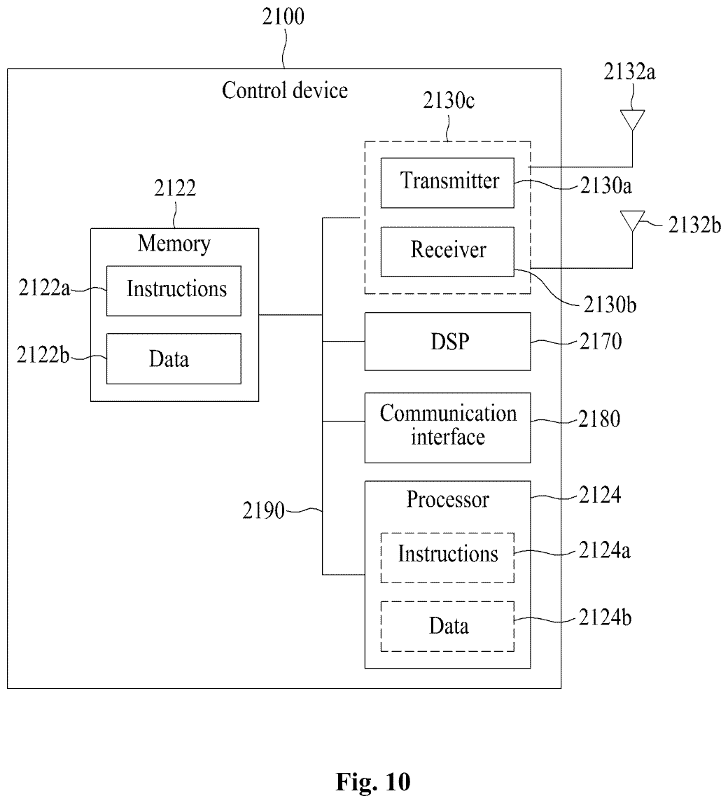

FIG. 9 is a block diagram illustrating a vehicle 2000 to which the image processing system 100 is mounted according to various example embodiments. FIG. 10 is a block diagram illustrating a control device 2100 of the vehicle 2000 of FIG. 9.

Referring to FIGS. 9 and 10, the image processing system 100 according to various example embodiments may be mounted to the vehicle 2000 and the vehicle 2000 may include the control device 2100. Here, the vehicle 2000 may be an autonomous vehicle. In some example embodiments, at least one component of the electronic device 100 may be integrated into at least one component of the control device 2100.

The control device 2100 may include a controller 2120 that includes a memory 2122 and a processor 2124, a sensor 2110, a wireless communication device 2130, a light detection and ranging device 2140 (for example, LIDAR), and a camera module 2150.

The controller 2120 may be configured at a time of manufacture by a manufacturing company of the vehicle 2000 or may be additionally configured to perform an autonomous driving function after manufacture. Alternatively, a configuration to continuously perform an additional function by upgrading the controller 2120 configured at the time of manufacture may be included.

The controller 2120 may forward a control signal to the sensor 2110, an engine 2006, a user interface (UI) 2008, the wireless communication device 2130, the LIDAR device 2140, and the camera module 2150 included as other components in the vehicle 2000. Although not illustrated, the controller 2120 may forward a control signal to an acceleration device, a braking system, a steering device, or a navigation device associated with driving of the vehicle 2000.

The controller 2120 may control the engine 2006. For example, the controller 2120 may sense a speed limit of a road on which the vehicle 2000 is driving and may control the engine 2006 such that a driving speed may not exceed the speed limit, or may control the engine 2006 to increase the driving speed of the vehicle 2000 within the range of not exceeding the speed limit. Additionally, when sensing modules 2004a, 2004b, 2004c, and 2004d sense an external environment of the vehicle 2000 and forward the same to the sensor 2110, the controller 2120 may receive external environment information, may generate a signal for controlling the engine 2006 or a steering device (not shown), and thereby control driving of the vehicle 2000.

When another vehicle or an obstacle is present in front of the vehicle 2000, the controller 2120 may control the engine 2006 or the braking system to decrease the driving speed and may also control a trajectory, a driving route, and a steering angle in addition to the speed. Alternatively, the controller 2120 may generate a necessary control signal according to recognition information of other external environments, such as, for example, a driving lane, a driving signal, etc., of the vehicle 2000, and may control driving of the vehicle 2000.

The controller 2120 may also control driving of the vehicle 2000 by communicating with a nearby vehicle or a central server in addition to autonomously generating the control signal and by transmitting an instruction for controlling peripheral devices based on the received information.

Further, if a location or an angle of view of the camera module 2150 is changed, it may be difficult for the controller 2120 to accurately recognize a vehicle or a lane. To prevent this, the controller 2120 may generate a control signal for controlling a calibration of the camera module 2150. Therefore, the controller 2120 may generate a calibration control signal for the camera module 2150 and may continuously maintain a normal mounting location, direction, angle of view, etc., of the camera module 2150 regardless of a change in a mounting location of the camera module 2150 by a vibration or an impact occurring due to a motion of the autonomous vehicle 2000. When prestored information on an initial mounting location, direction, and angle of view of the camera module 2150 differs from information on the initial mounting location, direction, and angle of view of the camera module 2150 that are measured during driving of the autonomous vehicle 2000 by a threshold or more, the controller 2120 may generate a control signal for performing the calibration of the camera module 2150.

The controller 2120 may include the memory 2122 and the processor 2124. The processor 2124 may execute software stored in the memory 2122 in response to the control signal of the controller 2120. In detail, the controller 2120 may store, in the memory 2122, data and instructions for detecting a visual field view from a rear view image of the vehicle 2000, and the instructions may be executed by the processor 2124 to perform at least one method disclosed herein.

Here, the memory 2122 may be stored in a recording medium executable at the non-volatile processor 2124. The memory 2122 may store software and data through an appropriate external device. The memory 2122 may include random access memory (RAM), read only memory (ROM), hard disk, and a memory device connected to a dongle.

The memory 2122 may at least store an operating system (OS), a user application, and executable instructions. The memory 2122 may store application data and arrangement data structures.

The processor 2124 may be a controller, a microcontroller, or a state machine as a microprocessor or an appropriate electronic processor.

The processor 2124 may be configured as a combination of computing devices. The computing device may be configured as a digital signal processor, a microprocessor, or a combination thereof.

Also, the control device 2100 may monitor internal and external features of the vehicle 2000 and may detect a state of the vehicle 2000 using at least one sensor 2110.

The sensor 2110 may include at least one sensing module 2004. The sensing module 2004 may be implemented at a specific location of the vehicle 2000 depending on a sensing purpose. The sensing module 2004 may be provided in a lower portion, a rear portion, a front end, an upper end, or a side end of the vehicle 2000 and may be provided to an internal part of the vehicle 2000, a tier, and the like.

Through this, the sensing module 2004 may sense driving information, such as the engine 2006, a tier, a steering angle, a speed, a vehicle weight, and the like, as internal vehicle information. Also, the at least one sensing module 2004 may include an acceleration sensor, a gyroscope, an image sensor, a radar, an ultrasound sensor, a LIDAR sensor, and the like, and may sense motion information of the vehicle 2000.

The sensing module 2004 may receive specific data, such as state information of a road on which the vehicle 2000 is present, nearby vehicle information, and an external environmental state such as weather, as external information, and may sense a vehicle parameter according thereto. The sensed information may be stored in the memory 2122 temporarily or in long-term depending on purposes.

The sensor 2110 may integrate and collect information of the sensing module 2004 for collecting information generated inside and outside the vehicle 2000.

The control device 2100 may further include the wireless communication device 2130.

The wireless communication device 2130 is configured to implement wireless communication between the vehicles 2000. For example, the wireless communication device 2130 enables the vehicles 2000 to communicate with a mobile phone of the user, another wireless communication device 2130, another vehicle, a central device (traffic control device), a server, and the like. The wireless communication device 2130 may transmit and receive a wireless signal based on a wireless communication protocol. The wireless communication protocol may be WiFi, Bluetooth, Long-Term Evolution (LTE), code division multiple access (CDMA), wideband code division multiple access (WCDMA), and global systems for mobile communications (GSM). However, it is provided as an example only and the wireless communication protocol is not limited thereto.

Also, the vehicle 2000 may implement vehicle-to-vehicle (V2V) communication through the wireless communication device 2130. That is, the wireless communication device 2130 may perform communication with another vehicle and other vehicles on the roads through the V2V communication. The vehicle 2000 may transmit and receive information, such as driving warnings and traffic information, through V2V communication and may also request another vehicle for information or may receive a request from the other vehicle. For example, the wireless communication device 2130 may perform the V2V communication using a dedicated short-range communication (DSRC) device or a celluar-V2V (CV2V) device. Also, in addition to the V2V communication, vehicle-to-everything (V2X) communication, communication between the vehicle 2000 and another object (e.g., electronic device carried by pedestrian), may be implemented through the wireless communication device 2130.

Also, the control device 2100 may include the LIDAR device 2140. The LIDAR device 2140 may detect an object around the vehicle 2000 during an operation, based on data sensed using a LIDAR sensor. The LIDAR device 2140 may transmit detection information to the controller 2120, and the controller 2120 may operate the vehicle 2000 based on the detection information. For example, when the detection information includes a vehicle ahead driving at a low speed, the controller 2120 may instruct the vehicle 2000 to decrease a speed through the engine 2006. Alternatively, the controller 2120 may instruct the vehicle 2000 to decrease a speed based on a curvature of a curve the vehicle 2000 enters.

The control device 2100 may further include the camera module 2150. The controller 2120 may extract object information from an external image captured from the camera module 2150, and may process the extracted object information using the controller 2120.

Also, the control device 2100 may further include imaging devices configured to recognize an external environment. In addition to the LIDAR device 2140, a radar, a GPS device, a driving distance measurement device (odometry), and other computer vision devices may be used. Such devices may selectively or simultaneously operate depending on necessity, thereby enabling further precise sensing.

The vehicle 2000 may further include the user interface (UI) 2008 for a user input to the control device 2100. The user interface 2008 enables the user to input information through appropriate interaction. For example, the user interface 2008 may be configured as a touchscreen, a keypad, and a control button. The user interface 2008 may transmit an input or an instruction to the controller 2120, and the controller 2120 may perform a vehicle control operation in response to the input or the instruction.

Also, the user interface 2008 may enable communication between an external device of the vehicle 2000 and the vehicle 2000 through the wireless communication device 2130. For example, the user interface 2008 may enable interaction with a mobile phone, a tablet, or other computer devices.

Further, although the example embodiment describes that the vehicle 2000 includes the engine 2006, it is provided as an example only. The vehicle 2000 may include a different type of a propulsion system. For example, the vehicle 2000 may run with electric energy, hydrogen energy, or through a hybrid system that is a combination thereof. Therefore, the controller 2120 may include a propulsion mechanism according to the propulsion system of the vehicle 2000 and may provide a control signal according thereto to each component of the propulsion mechanism.

Hereinafter, a configuration of the control device 2100 for using the rear view image 200 of the vehicle 2000 for a plurality of functions is described with reference to FIG. 10.

The control device 2100 may include the processor 2124. The processor 2124 may be a general-purpose single or multi-chip microprocessor, a dedicated microprocessor, a microcontroller, a programmable gate array, and the like. The processor 2124 may also be referred to as a central processing unit (CPU). Also, the processor 2124 may be a combination of a plurality of processors 2124.

The control device 2100 also includes the memory 2122. The memory 2122 may be any electronic component capable of storing electronic information. The memory 2122 may include a combination of memories 2122 in addition to a unit memory.

According to various example embodiments, data 2122b and instructions 2122a for using the rear view image 200 of the vehicle 2000 for the plurality of functions may be stored in the memory 2122. When the processor 2124 executes the instructions 2122a, the instructions 2122a and a portion or all of the data 2122b required to perform the instructions 2122a may be loaded to the processor 2124 as indicated with dotted lines 2124a and 2124b.

The control device 2100 may include a transmitter 2130a and a receiver 2130b, or a transceiver 2130c, to allow transmission and reception of signals. At least one antenna, for example, antennas 2132a and 2132b, may be electrically connected to the transmitter 2130a and the receiver 2130b, or the transceiver 2130c, and may include additional antennas.

The control device 2100 may include a digital signal processor (DSP) 2170, and may control the vehicle 2000 to quickly process a digital signal through the DSP 2170.

The control device 2100 may also include a communication interface 2180. The communication interface 2180 may include one or more ports and/or communication modules configured to connect other devices to the control device 2100. The communication interface 2180 may enable interaction between the user and the control device 2100.

Various components of the control device 2100 may be connected through one or more buses 2190, and the buses 2190 may include a power bus, a control signal bus, a state signal bus, and a database bus. Under the control of the processer 2124, the components may forward mutual information through the buses 2190 and may perform desired functions.

The apparatuses described herein may be implemented using hardware components, software components, and/or a combination of the hardware components and the software components. For example, the apparatuses and the components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, other processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, computer storage medium or device, to provide instructions or data to the processing device or be interpreted by the processing device. The software also may be distributed over network coupled computer systems so that the software is stored and executed in a distributed fashion. The software and data may be stored by one or more computer readable storage mediums.

The methods according to various example embodiments may be implemented in a form of a program instruction executable through various computer methods and recorded in computer-readable media. Here, the media may be to continuously store a computer-executable program or to temporarily store the same for execution or download. The media may be various types of record methods or storage methods in which single piece of hardware or a plurality of pieces of hardware are combined and may be distributed over a network without being limited to a medium that is directly connected to a computer system. Examples of the media include magnetic media such as hard disks, floppy disks, and magnetic tapes; optical media such as CD ROM and DVD; magneto-optical media such as floptical disks; and hardware devices that are specially configured to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software.

Various example embodiments and the terms used herein are not construed to limit description disclosed herein to a specific implementation and should be understood to include various modifications, equivalents, and/or substitutions of a corresponding example embodiment. In the drawings, like reference numerals refer to like components throughout the present specification. The singular forms “a,” “an,” and “the” are intended to include the plural forms as well, unless the context clearly indicates otherwise. Herein, the expressions, “A or B,” “at least one of A and/or B,” “A, B, or C,” “at least one of A, B, and/or C,” and the like may include any possible combinations of listed items. Terms “first,” “second,” etc., are used to describe corresponding components regardless of order or importance and the terms are simply used to distinguish one component from another component. The components should not be limited by the terms. When a component (e.g., first component) is described to be “(functionally or communicatively) connected to” or “accessed to” another component (e.g., second component), the component may be directly connected to the other component or may be connected through still another component (e.g., third component).

The term “module” used herein may include a unit configured as hardware, software, or firmware, and may be interchangeably used with the terms, for example, “logic,” “logic block,” “part,” “circuit,” etc. The module may be an integrally configured part, a minimum unit that performs one or more functions, or a portion thereof. For example, the module may be configured as an application-specific integrated circuit (ASIC).

According to various example embodiments, each of the components (e.g., module or program) may include a singular object or a plurality of objects. According to various example embodiments, at least one of the components or operations may be omitted. Alternatively, at least one another component or operation may be added. Alternatively or additionally, a plurality of components (e.g., modules or programs) may be integrated into a single component. In this case, the integrated component may perform one or more functions of each of the components in the same or similar manner as it is performed by a corresponding component before integration. According to various example embodiments, operations performed by a module, a program, or another component may be performed in a sequential, parallel, iterative, or heuristic manner. Alternatively, at least one of the operations may be performed in different sequence or omitted. Alternatively, at least one another operation may be added.

What is claimed is:

1. An electronic device connected to a camera device that captures a rear view image of a vehicle, the electronic device comprising:
an interface module configured to communicatively connect to the camera device; and
a processor configured to connect to the interface module, and to process the rear view image received through the interface module to a plurality of target images for a plurality of functions.

2. The electronic device of claim 1, further comprising:
a memory configured to connect to the processor,
wherein the processor is configured to store the rear view image in the memory as a first target image.

3. The electronic device of claim 2, further comprising:
a communication module configured to connect to the processor,
wherein the processor is configured to acquire location information through the communication module and to store the location information in the memory with a first target image.

4. The electronic device of claim 2, wherein a resolution of the first target image is the same as that of the rear view image, and
a resolution of at least one of the target images is less than that of the rear view image.

5. The electronic device of claim 1, further comprising:
a display module configured to connect to the processor,
wherein the processor is configured to display a portion of the rear view image on the display module as a second target image that is a portion of an around view image around the vehicle.

6. The electronic device of claim 5, wherein the processor is configured to detect a lower central portion of the rear view image, to convert the detected portion to the second target image, and to display the second target image on the display module.

7. The electronic device of claim 1, further comprising:
a digital rear mirror configured to connect to the processor,
wherein the processor is configured to display a portion of the rear view image on the digital rear mirror as a third target image.

8. The electronic device of claim 7, wherein the processor is configured to detect a predetermined partial area of the rear view image, to convert a portion of the detected area to the third target image based on preset mirror variables, and to display the third target image on the digital rear mirror.

9. The electronic device of claim 8, wherein the mirror variables include at least one of a size and a location of the portion in the detected area, and
the processor is configured to adjust at least one of the size or the location based on a user input.

10. The electronic device of claim 1, wherein the processor comprises:
a preprocessing module configured to duplicate the rear view image and to generate a plurality of rear view images; and
a plurality of processing modules assigned with the functions, respectively, and configured to receive the rear view images, respectively, and to process the rear view images to the target images according to the functions, respectively.

11. An operating method of an electronic device connected to a camera device that captures a rear view image of a vehicle, the method comprising:
receiving the rear view image from the camera device; and
processing the rear view image to a plurality of target images for a plurality of functions.

12. The method of claim 11, wherein the processing to the target images comprises storing the rear view image in a memory as a first target image.

13. The method of claim 12, further comprising:
acquiring location information of the electronic device,
wherein the storing in the memory comprises storing the location information in the memory with the first target image.

14. The method of claim 12, wherein a resolution of the first target image is the same as that of the rear view image, and
a resolution of at least other one of the target images is less than that of the rear view image.

15. The method of claim 11, wherein the processing to the target images comprises displaying a portion of the rear view image on a display module as a second target image that is a portion of an around view image around the vehicle.

16. The method of claim 15, wherein the displaying on the display module comprises:
detecting a lower central portion of the rear view image;
converting the detected portion to the second target image; and
displaying the second target image on the display module.

17. The method of claim 11, wherein the processing to the target images comprises displaying a portion of the rear view image on a digital rear mirror as a third target image.

18. The method of claim 17, wherein the displaying on the digital rear mirror comprises:
detecting a predetermined partial area of the rear view image;
converting a portion of the detected area to the third target image based on preset mirror variables; and
displaying the third target image on the digital rear mirror.

19. The method of claim 18, wherein the mirror variables include at least one of a size and a location of the portion in the detected area, and
at least one of the size and the location is adjustable based on a user input.

20. A image processing system comprising:
a camera device configured to capture a rear view image of a vehicle; and
an electronic device configured to process the rear view image to a plurality of target images for a plurality of functions.
